(19) United States
(12) Patent Application Publication
(10) Pub. No.: US 2005/0063051 A1
(43) Pub. Date: Mar. 24, 2005

(54) Arrangement for the direct inout coupling of a laser, particularly of a short-pulse laser

(76) Inventors: Ralph Lange, Jena (DE); Stefan Wilhelm, Jena (DE); Volker Gerstner, Jena (DE); Roland Scheler, Jena (DE); Michael Goelles, Jena (DE); Joerg-Michael Funk, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/888,186

(22) Filed: Jul. 9, 2004

(30) Foreign Application Priority Data
Jul. 11, 2003 (DE) 103 32 074.1

(51) Int. Cl. G02B 21/06; G02B 21/00

(52) U.S. Cl. 359/385; 359/368

(57) ABSTRACT

An arrangement for direct input coupling of a laser, preferably of a short-pulse laser, for nonlinear sample excitation which is located outside of the microscope housing, into the beam path of a laser scanning microscope (LSM), comprising a housing in which is integrated an adjusting laser that can be coupled into the microscope beam path by beam splitters, wherein the housing is advantageously integrated so as to be insertable in the scan module of the LSMA, and a beam splitter for the direct coupling laser has high transmission in the direction of the objective and, further, partial transmission for back-reflections of the adjusting laser coming from the specimen for adjusting the overlapping of the adjusting laser and direct coupling laser.

### CROSS-REFERENCE TO RELATED APPLICATION

This application claims priority of German Application No. 103 32 074.1, filed Jul. 11, 2003, the complete disclosure of which is hereby incorporated by reference.

### BACKGROUND OF THE INVENTION

a) Field of the Invention

The invention is directed to an input-coupling module, according to the invention, for free-beam coupling of a laser, particularly of a NIR short-pulse laser, which is located outside of the microscope housing.

### BRIEF DESCRIPTION OF THE DRAWING

In the drawing:

FIG. 1 illustrates a representation view of the invention.

### DESCRIPTION OF THE PREFERRED EMBODIMENTS

The module advantageously forms an insertable mechanical unit MO which can be a service interface at the laser scanning microscope in which is integrated an adjusting laser JL that advantageously has a wavelength in the visible range.

This adjusting laser is coupled into the microscope beam path by input-coupling lens L, fixed collimator KO, deflecting mirror S1 and beam unifier SV. The coupling in of the direct coupling laser is carried out by an adjustable direct coupling lens L1.

Initially, however, the coupling-in module is preadjusted, for example, by means of an external laser at the location of the direct coupling laser, by which the adjustable collimator lens KO1 is preadjusted, for example, by means of an autocollimating telescope.

Subsequently, the internal adjusting laser, the mirror S1, the beam unifier S2 and the collimator KO1 are aligned with respect to on another so that the beam of the adjusting laser is collinear to the optical axis of the unit MO. This can be carried out in that the adjusting laser or, for example, the deflecting mirror S1 can be tilted in two directions.

Now, at the latest, the module is inserted into the microscope housing. The subsequent elements of the illumination module of the microscope, such as the telescope, scanner, scanning objective, can now be lined up with the beam of the adjusting laser.

The direct coupling laser which operates, e.g., in the near IR range and is faintly visible on the specimen or an adjusting mirror is subsequently directly coupled in and aligned with the adjusting laser in that the beams are made to overlap.

For this purpose, a mirror is advantageously placed under the objective and the back-reflection of the adjusting laser passes through the beam unifier S2.

For this purpose, the beam unifier advantageously has full transmission with respect to the short-pulse laser and partial transmission of preferably 50% for the adjusting laser.

This makes it possible to overlap the beam of the adjusting laser collinear to the beam of the direct coupling laser in direction of the objective and, on the other hand, to couple out a portion of the adjusting laser reflected in the specimen plane by means of the direct coupling port. The adjusting laser is overlapped collinear to the direct coupling laser outside of the microscope housing. The direct coupling laser is oriented by several degrees of freedom, for example, tiltable deflecting mirrors, in that the beams coming from different directions are checked for overlapping and aligned at one or more observation points before the direct input coupling, for example, by means of a diffusing disk.

For a full description of a LSM beam path, reference is had to DE 197 02 753 A1.

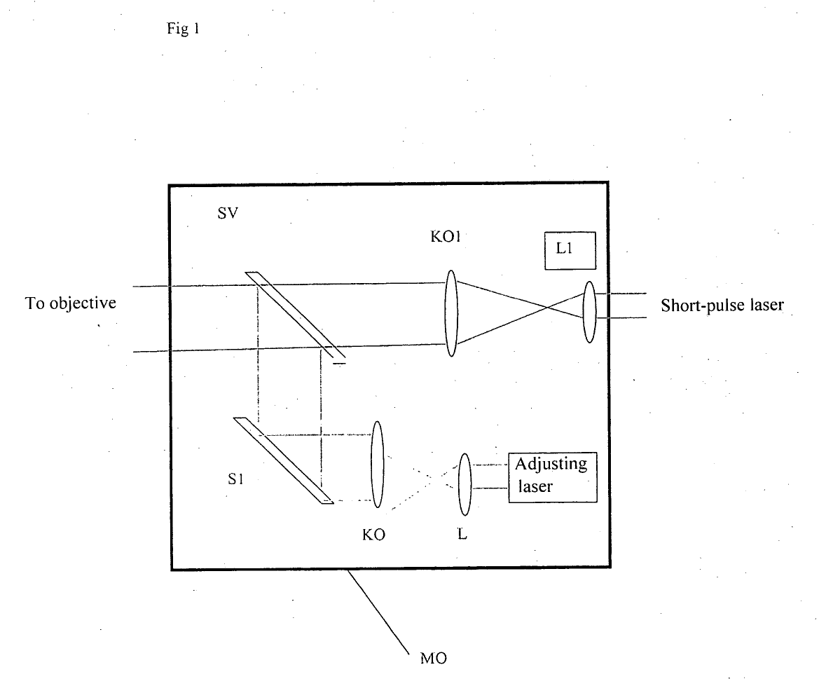

The insertable module according to the invention would be located in the scan module S in FIG. 1 and the direct coupling laser would be coupled in directly from the outside.

While the foregoing description and drawings represent the present invention, it will be obvious to those skilled in the art that various changes may be made therein without departing from the true spirit and scope of the present invention.

1-5. (cancelled).

6. An arrangement for direct input coupling of a laser, such as a short-pulse laser, for nonlinear sample excitation which is located outside of the microscope housing, into the beam path of a laser scanning microscope (LSM), comprising:
a housing in which an adjusting laser is integrated that can be coupled into the microscope beam path by beam splitters.

7. The arrangement according to claim 6, wherein the housing is integrated so as to be insertable in the scan module of the LSM.

8. The arrangement according to claim 6, wherein a beam splitter for the direct coupling laser has high transmission in the direction of the objective and, further, partial transmission for back-reflections of the adjusting laser coming from the specimen for adjusting the overlapping of the adjusting laser and direct coupling laser.

9. The arrangement according to claim 6, wherein a direct coupling lens is provided in the housing for the direct coupling laser.

10. The arrangement according to claim 6, wherein adjustable input-coupling optics are provided in the housing for the direct coupling laser.
